(19) United States
(12) Patent Application Publication
(10) Pub. No.: US 2008/0178489 A1
(43) Pub. Date: Jul. 31, 2008

(54) Shaver saver

(76) Inventor: Roger Dionne, Unionville, CT (US)

Correspondence Address: JAMES RAY & ASSOCIATES, 2640 PITCAIRN ROAD, MONROEVILLE, PA, 15146, US

(21) Appl. No.: 12/008,742

(22) Filed: Jan. 14, 2008

Related U.S. Application Data
(60) Provisional application No. 60/884,901, filed on Jan. 15, 2007.

(51) Int. Cl. F26B 19/00; F26B 21/02

(52) U.S. Cl. 34/202; 34/229

(57) ABSTRACT

An apparatus for drying a disposable razor so as to prevent corrosion due to moisture left on such razor. The apparatus comprising a container having a predetermined shape and formed of a predetermined material. The container is designed for holding at least one such disposable razor. There is a base portion of the container, such base portion being removably engageable with a bottom part of the container, such base portion including a foot member and a housing member. A fan is disposed in the housing of such base portion of the container. A screen is disposed in the base portion of the container atop the fan. The apparatus has a power means disposed in one of the housing and the foot member of the base portion of the container for providing power to the fan. A switch means has a first portion disposed on one of the housing and the foot member of the base portion of the container and has a second portion of the switch being in electrical communication with the power means and the fan for controlling the operation of the fan.

### CROSS REFERENCE TO RELATED APPLICATIONS

This application is closely related to and claims benefit from U.S. Provisional Application Ser. No. 60/884,901 filed Jan. 15, 2007.

### FIELD OF THE INVENTION

The present invention relates, in general, to razors, and, more particularly, the present invention relates to a quick dry system designed to stop corrosion of disposable razor blades due to corrosion.

### BACKGROUND OF THE INVENTION

Most manual razors are made with stainless steel blades that are prone to corrosion and rusting after even the first use if any water remains on the blades. This dulling can be dangerous, especially to sensitive skin as well as costly, as the consumer must replace the blades or the entire razor quite often. Thus, even disposable razors do not have the useful life that they should have because of the corrosion of the blade. Most people after shaving merely shake the razor to get rid of excess water but some moisture still remains on the blade and those that do not do even this small preventative step put the razor away with water droplets on the razor.

Thus, it would be advantageous if there were an effective means of drying and storing disposable razors so as to prevent corrosion to the blades and thereby extending the life of such razor.

### SUMMARY OF THE INVENTION

In a first aspect the present invention provides an apparatus for drying a disposable razor so as to prevent corrosion due to moisture left on such razor. The apparatus comprising a container member having a predetermined shape and formed of a predetermined material. The container member is designed for holding at least one such disposable razor. There is a base portion of the container to member, such base portion being removably engageable with a bottom part of the container member, such base portion including a foot member and a housing member. A fan member is disposed in the housing member of such base portion of the container member. A screen member is disposed in the base portion of the container member atop the fan member. The apparatus has a power means disposed in one of the housing member and the foot member of the base portion of the container member for providing power to the fan member. A switch means has a first portion disposed on one of the housing member and the foot member of the base portion of the container member and has a second portion of the switch means being in electrical communication with the power means and the fan member for controlling the operation of the fan member.

In a second aspect the present invention provides an apparatus for drying a disposable razor so as to prevent corrosion due to moisture left on such razor. The apparatus comprises a container member having a predetermined shape and formed of a predetermined material. The container member holds at least one such disposable razor. There is a housing member of the container member, such housing member being removeably engageable with the top of the container member. A fan member is disposed in the housing member of the container member. A power means is disposed in the housing member of the container member for providing power to the fan member. The apparatus includes a switch means which has a first portion disposed on the housing member and a second portion of the switch means being in electrical communication with the power means and the fan member for controlling the fan member. The apparatus also includes an opening disposed on a wall portion of the container member for permitting such disposable razor to be placed in such container member.

### OBJECTS OF THE INVENTION

It is, therefore, one of the primary objects of the present invention to provide an apparatus for effectively drying disposable razors.

Another object of the present invention is to provide an apparatus that will eliminate corrosion of the razor blade due to moisture left on the blade after use.

Still another object of the present invention is to provide an apparatus for drying a razor than is easy to use.

In addition to the various objects and advantages of the invention which have been described in some specific detail above it should be noted that various other objects and advantages of the present invention will become more readily apparent to those persons who are skilled in the relevant art from the following more detailed description, particularly when such description is taken in conjunction with the appended claims.

### BRIEF DESCRIPTION OF THE DRAWINGS

FIG. 1 is a front perspective view of the apparatus showing two razors disposed therein according to an embodiment of the invention.

FIG. 2 is a perspective view of a partially exploded view of the apparatus shown in FIG. 1.

FIG. 3 is an exploded view of the bottom portion of the apparatus shown in FIG. 1.

FIG. 4 is a front perspective view of the apparatus for drying a razor according an alternate embodiment of the invention.

FIG. 5 is a front perspective view of the apparatus shown in FIG. 4 showing yet another embodiment.

FIG. 6 is a block diagram showing the electrical flow of the equipment needed for the operation of the fan.

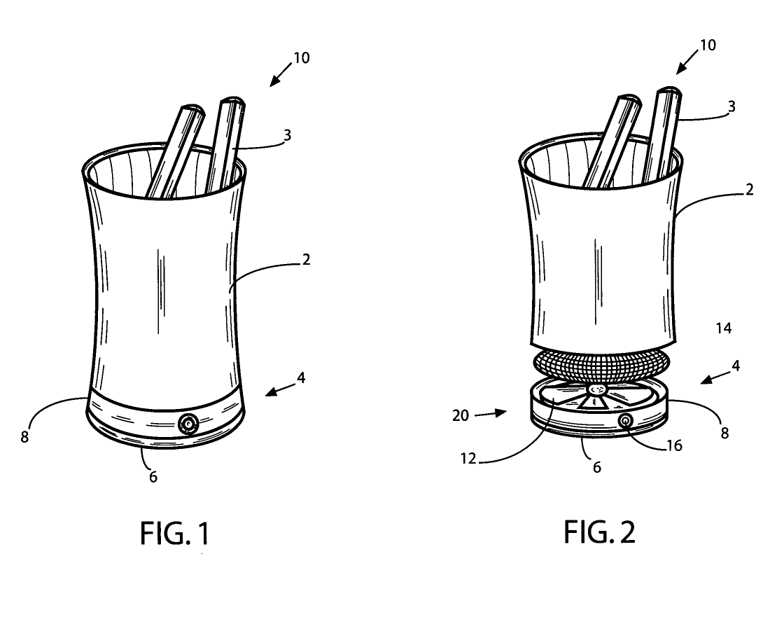

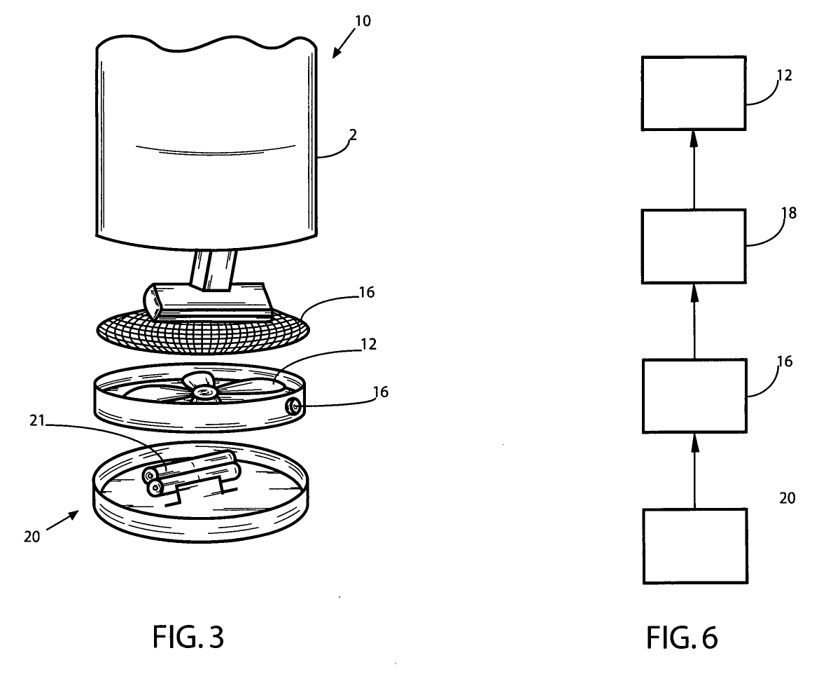

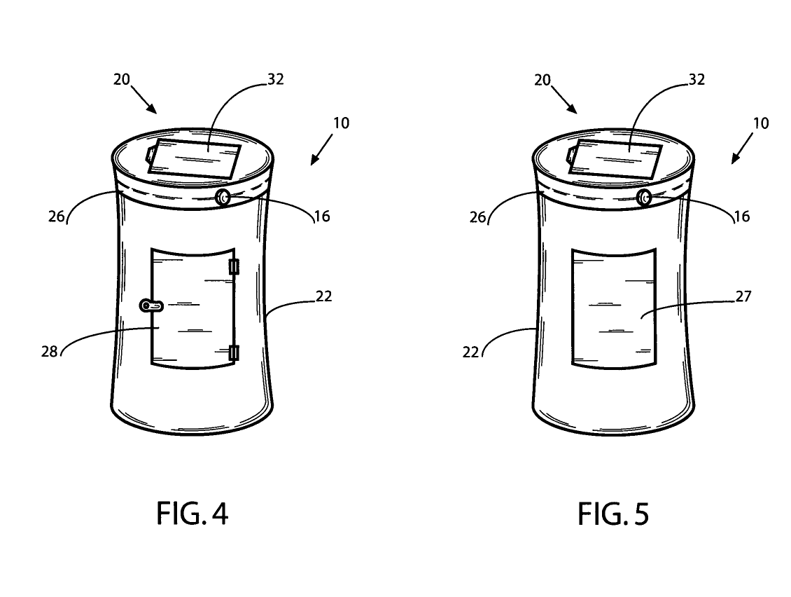

### BRIEF DESCRIPTION OF THE PRESENTLY PREFERRED AND VARIOUS ALTERNATIVE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides an apparatus, generally designated 10, for drying a disposable razor so as to prevent corrosion due to moisture left on such razor. The apparatus 10 comprises a container member 2 having a predetermined shape and formed of a predetermined material, such container member is designed for holding at least one such disposable razor 3. The container member 2 has base portion 4. Such base portion being removably engageable with a bottom part of the container member 2. The base portion 4 includes a foot member 6 and a housing member 8. A fan member 12 is disposed in the housing member 8 of the base portion 4 of the container member. There is also a screen member 14 that is disposed in the base portion 4 of the container member 2 atop the fan member 12. The blade portion of the disposable razor 5 sits on top of the screen 14.

The apparatus 10 includes a power means, generally designated 20, that is disposed in either the housing member or the foot member 6 of the base portion 4 of the container member 2 for providing power to the fan member 12 and a switch means 16 which has a first portion disposed on either the housing member 8 or the foot member 6 of the base portion 4 of the container member 2 and a second portion of the switch means 16 being in electrical communication with the power means 20 and the fan member 12 for controlling the fan member 12.

The base portion 4 is removably engageable with the container member 2 by one of a threaded means and a friction fit. It is presently preferred that such base portion 4 is removably engageable with the container member 2 by a friction fit. It should be noted that such housing member 8 and such foot member 6 of the base member could be formed as one piece. If this is done then the bottom of member would have removable section for replacement of batteries.

It is also presently preferred that such switch means 16 is a push button 16 and that the power means 20 includes at least one battery 21 and even more preferred if such power means 20 is two batteries 21 and that such batteries are AA batteries.

The fan when activated by depressing such push button 16 operates for a predetermined time. The time is controlled by a timer means 18 which determines the predetermined time which the fan 12 will operate when activated. Presently it is preferred that such predetermined time is 60 seconds which should be sufficient to dry the razor 3 and remove any excess water remaining on the razor.

The predetermined material for forming such container member 2 is selected from ceramic, glass and plastic and it is presently preferred that such material is plastic. The predetermined shape of the container member 2 is one of cylindrical and rectangular and it is presently preferred that such shape is cylindrical.

In a second aspect the present invention provides an apparatus for drying a disposable razor so as to prevent corrosion due to moisture left on such razor. The apparatus comprises a container member 22 having a predetermined shape and formed of a predetermined material. The container member 22 for holding at least one such disposable razor 3. There is a housing member 26, such housing member 26 being removably engageable with the top of the container member 22.

A fan member 12 is disposed in the housing member 26 of the top portion 24 of the container member 22. A power means 20 is disposed in the housing member 26 of the container member 22 for providing power to the fan member 12.

The apparatus 10 includes a switch means 16 which has a first portion disposed on the housing member 26 of the container member 22 and a second portion of the switch means 16 being in electrical communication with the power means 20 and the fan member 12 for controlling the fan member 12. The apparatus also includes an opening 27 disposed in a wall portion of the container member 22 for permitting such disposable razor 3 to be placed in such container member 22. It is also with in the scope of the invention that such opening 27 disposed on a wall portion of the container member 22 may further include a door member 28. In this embodiment the razor 3 is placed in the container member with the blade portion of the razor in the top of the container member 22 so that the fan 12 blows directly on the blade(s).

It should be noted that such apparatus is designed for one of sitting on a shelf and being wall mounted.

Such apparatus further includes a means 32 for replacing batteries 21 disposed in the housing member 26. Such means 32 includes a removably engageable section from a top exterior surface of the housing member 26.

Such top portion 24 is removably engageable with the container member 22 by one of a threaded means and a friction fit. It is presently preferred that such top portion 24 is removably engageable with the container member 22 by means of a friction fit.

Thus, the present invention provides a quick dry system for designed to stop corrosion of disposable razor blades due to moisture on the blades. The apparatus is a round cup-like container that will hold one or more disposable razors, head down for drying and storage. (Or head up in the case of the second aspect.) The apparatus provides a small CPU style, battery operated fan in the bottom of the unit that blows upward, effectively drying the blades of the razor. The unit includes a battery system for powering the fan and a timer means for controlling the length of time the fan operates. The razor sits atop of a screen in the bottom of the container member that enables direct contact with the fan blown air. A push button (switch means) is used to initialize the fan operation. The fan cycles at high speed for approximately 60 seconds (as determined by the timer) before stopping. The base portion of the unit is easily removed from the container since is secured by a friction fit when battery replacement is necessary. The unit is sized to fit in all standard size medicine cabinets.

Thus, after shaving the user simply rinses the razor, shakes off any excess water as normal and places the razor in the container. The push button is depressed and the razor is dried automatically. The unit has an approximate 3¾ diameter and a height of approximately 4½ inches.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

I claim:

1. An apparatus for drying a disposable razor so as to prevent corrosion due to moisture left on such razor, said apparatus comprising:
(a) a container member having a predetermined shape and formed of a predetermined material, said container member for holding at least one such disposable razor;
(b) a base portion of said container member, said base portion being removably engageable with a bottom part of said container member, said base portion including a foot member and a housing member;
(c) a fan member disposed in said housing member of said base portion of said container member;
(d) a screen member disposed in said base portion of said container member atop said fan member;
(e) a power means disposed in one of said housing member and said foot member of said base portion of said container member for providing power to said fan member; and
(f) a switch means having a first portion disposed on one of said housing member and said foot member of said base portion of said container member and a second portion of said switch means being in electrical communication with said power means and said fan member for controlling said fan member.

2. The apparatus, according to claim 1, wherein said base portion is removably engageable with said container member by one of a threaded means and a friction fit.

3. The apparatus, according to claim 2, wherein said base portion is removably engageable with said container member by means of a friction fit.

4. The apparatus, according to claim 1, wherein switch means is a push button.

5. The apparatus, according to claim 1, wherein said power means is at least one battery.

6. The apparatus, according to claim 5, wherein said power means is two batteries.

7. The apparatus, according to claim 6, wherein said batteries are AA batteries.

8. The apparatus, according to claim 4, wherein said fan operates for a predetermined time when activated by depressing said push button.

9. The apparatus, according to claim 8, wherein said apparatus further includes a timer means for controlling said predetermined time said fan operates when activated.

10. The apparatus, according to claim 9, wherein said predetermined time is 60 seconds.

11. The apparatus, according to claim 1, wherein said predetermined material is one of glass and plastic.

12. The apparatus, according to claim 11, wherein said predetermined mater is plastic.

13. The apparatus, according to claim 1, wherein said predetermined shape of said container member is one of substantially cylindrical and substantially rectangular.

14. An apparatus for drying a disposable razor so as to prevent corrosion due to moisture left on such razor, said apparatus comprising:
(a) a container member having a first predetermined shape and formed of a predetermined material, said container member for holding at least one such disposable razor;
(b) a removable housing member engageable with a top of said container member, said housing member having a second predetermined shape.
(c) a fan member disposed in said housing member;
(d) a power means disposed in said housing member for providing power to said fan member;
(e) a switch means having a first portion disposed on said housing member and a second portion of said switch means being in electrical communication with said power means and said fan member for controlling said fan member into on and off positions; and
(f) an opening disposed in a wall portion of said container member for permitting such disposable razor to be placed in said container member.

15. The apparatus, according to claim 14, wherein said apparatus is designed for one of sitting on a shelf of a medicine cabinet and being wall mounted.

16. The apparatus, according to claim 14, wherein said housing member further includes a means for replacing batteries disposed in said housing member.

17. The apparatus, according to claim 16, wherein said means for replacing batteries includes a removable section from a portion of said housing member.

18. The apparatus, according to claim 1, wherein said removable housing member is engageable with said container member by one of a threaded means and a friction fit.

19. The apparatus, according to claim 2, wherein said removable housing member is removably engageable with said container member by means of a friction fit.

20. The apparatus, according to claim 14, wherein said apparatus further includes a door member for closing said opening disposed in said wall portion of said container member.
